(19) United States
(12) Patent Application Publication
(10) Pub. No.: US 2016/0211794 A1
(43) Pub. Date: Jul. 21, 2016

(54) SOLAR CELL ASSEMBLY AND HIGH CONCENTRATION SOLAR CELL MODULE INCLUDING SAME

(71) Applicant: ANYCASTING CO., LTD., Seoul (KR)

(72) Inventors: Jangkyun KIM, Bucheon-si, Gyeonggi-do (KR); Kunwoong KO, Seoul (KR); Sungbin KIM, Goyang-si, Gyeonggi-do (KR)

(73) Assignee: ANYCASTING CO., LTD., Seoul (KR)

(21) Appl. No.: 14/914,259

(22) PCT Filed: Oct. 31, 2013
(86) PCT No.: PCT/KR2013/009809

§ 371 Date: Feb. 25, 2016

(30) Foreign Application Priority Data
Oct. 30, 2013 (KR) 10-2013-0129755
Oct. 30, 2013 (KR) 10-2013-0129756

(51) Int. Cl. H02S 30/10; H02S 40/42; H02S 40/22

(52) U.S. Cl. CPC H02S 30/10; H02S 40/22; H02S 40/425

(57) ABSTRACT

The present invention relates to a solar cell assembly and a high concentration solar cell module including the same and, particularly, to a solar cell assembly which can improve a heat radiating function and assembling efficiency with only a simple configuration and a high concentration solar cell module which can easily assemble the solar cell assembly. The solar cell assembly, according to the present invention, comprises: a heat pipe elongated in the length direction; a circuit board on which a plurality of solar cells are mounted, and which is attached to the heat pipe; and a wire for enabling the plurality of solar cells to conduct electricity.

### TECHNICAL FIELD

The present invention relates to a solar cell assembly and a high concentration solar cell module including the same, and more particularly, to a solar cell assembly for enhancing a heat dissipation function and assembly with a simple configuration and a high concentration solar cell module for ease assembly of the solar cell assembly.

### BACKGROUND ART

Recently, photovoltaic (PV) apparatuses using solar light been widely used. Particularly, photovoltaic apparatuses using silicon solar cells are mainly used.

By virtue of rapid process in technology pertaining to high efficiency III-V compound semiconductor multi-junction solar cells in recent years, researches have been actively conducted on concentrating photovoltaic (CPV) apparatuses using a method of concentrating solar light on multi-junction solar cells through inexpensive devices.

Multi-junction solar cells have high energy conversion efficiency compared to that of silicon solar cells. Generally, multi-junction solar cells have an energy efficiency of more the 35% while silicon solar cells have an energy efficiency of approximately 20%. Specially, under conditions of light concentration, some multi-junction solar cells have energy efficiency of more the 40%.

A concentrating solar cell module using such multi-junction solar cells includes solar cells, a primary lens for primarily concentrating solar light, and a secondary lens for secondarily concentrating on the solar cells the solar light concentrated by the primary lens. The solar cells are mounted to a cell mount such as a circuit board, or a receiver, for example, disclosed in Korean Patent Unexamined Publication No. 10-2010-0135200.

Concentrating photovoltaic generation systems are configured in such a way that a plurality of concentrating solar cell modules are provided in an array form on a support frame. Furthermore, the concentrating photovoltaic generation systems include a tracking device for rotating the solar cell module array such that the solar cell modules may be maintained to be perpendicular to the sun, thus enhancing the efficiency of the multi-junction solar cells.

The efficiency of III-V compound semiconductor solar cells that are mainly used for concentrating photovoltaic modules is remarkably degraded by heat, and thus, concentrating photovoltaic modules include a heat dissipation device for dissipation of heat generated from the solar cell.

Korean Patent Publication No. 10-2010-0083945 discloses a “heat dissipation module of high-concentrating photovoltaic apparatus”. However, the dissipation module includes a heat dissipation pin that protrudes upwards and downward, and thus there is a problem in that the volume of the module increases and the heat dissipation module needs to be separately assembled to the high-concentrating photovoltaic apparatus.

As another example, Korean Patent Publication No. 10-2011-0036221 discloses a “photovoltaic generation apparatus” including a heat pipe. However, there is a problem in that the photovoltaic generation apparatus has a complex structure for installing the heat pipe.

### DISCLOSURE

### Technical Problem

An object of the present invention devised to solve the problem lies in a solar cell assembly for enhancing a heat dissipation function and assembly with a simple configuration and a high concentration solar cell module for ease assembly of the solar cell assembly.

### Technical Solution

The object of the present invention can be achieved by providing a solar cell assembly including a heat pipe extending in a longitudinal direction, a circuit board including a solar cell mounted thereon and adhered to the heat pipe, and a wire for electrically connecting the plurality of solar cells to each other.

In another aspect of the present invention, provided herein is a high concentration solar cell module including a frame including a side plate and a lower plate, a solar cell assembly including a solar cell and coupled to the lower plate, and a lens plate disposed on the frame and concentrating incident light to the solar cell, wherein the solar cell assembly includes a heat pipe extending in a longitudinal direction, a circuit board including a solar cell mounted thereon and adhered to the heat pipe, and a wire for electrically connecting the plurality of solar cells to each other, and a pair of accommodation portion formation ribs extends and protrudes in a horizontal direction so as to dispose an accommodation portion for accommodating the heat pipe on the lower plate, and a dissipation rib protrudes below the lower plate.

### Advantageous Effects

A solar cell assembly with the aforementioned configuration according to the present invention may be configured in such a way that a circuit board with a solar cell installed thereon is adhered directly onto a heat pipe that has its own heat dissipation function and extends in a longitudinal direction so as to smoothly dissipate heat generated from the solar cell to a wide area in a longitudinal direction of the heat pipe.

A solar cell assembly according to the present invention may be configured in such a way that a plurality of circuit boards are arranged in a longitudinal direction of a heat pipe so as to effectively transfer heat generated from a plurality of solar cells in the longitudinal direction of the heat pipe, thereby enhancing a heat dissipation effect.

A solar cell assembly according to the present invention may be configured in such a way that a thermally conductive pressing member sheet such as a low melting point solder containing tin (Sn), indium (In), silver (Ag), copper (Cu), and so on is interposed between a circuit board and a heat pipe so as to more smoothly dissipate heat generated from a solar cell.

A solar cell assembly according to the present invention may be configured in such a way that a plurality of circuit boards including a solar cell installed thereon is adhered to one heat pipe, thereby simplifying overall configuration and assembly.

A solar cell assembly according to the present invention may be configured in such a way that a wire for connection between a plurality of solar cells includes a ribbon wire that is not peeled off, and thus a separate wire cover configuration for protection of the wire from sunlight is not required, thereby simplifying overall configuration and assembly.

A solar cell assembly according to the present invention may be configured in such a way that a ribbon wire that is not peeled off has its own insulation structure, and thus a separate configuration for insulation is not required, thereby simplifying overall configuration and assembly.

A solar cell assembly according to the present invention may be configured in such a way that a secondary lens covers a circuit board, and thus a separate configuration for protection of a solar cell and the circuit board is not required, thereby simplifying overall configuration and assembly.

A solar cell assembly according to the present invention may be configured in such a way that a circuit board is disposed in a groove formed in a longitudinal direction of a heat pipe, and thus the secondary lens may be easily installed on the circuit board.

A solar cell assembly according to the present invention may be configured in such a way that the depth of a groove formed in a heat pipe is greater than the sum of the thickness of a circuit board and the thickness of a solar cell, and thus a lower surface of a cover portion of a secondary lens and a lower surface of a lens portion are disposed in substantially parallel to each other without interference of a solar cell positioned below the secondary lens so as to easily manufacture the secondary lens.

A solar cell assembly according to the present invention may be configured in such a way that a solar cell and a lower surface of a lens portion of a secondary lens are adhered to each other by a transparent sealing member, and thus it is easy to seal the solar cell.

A solar cell assembly according to the present invention may be configured in such a way that a solar cell assembly is fixed to a lower plate without separate screw-coupling so as to simplify overall configuration and assembly, and thus the solar cell assembly with an enhanced heat dissipation function and assembly with a simple configuration may be easily assembled with the module.

A solar cell assembly according to the present invention may be configured in such a way that a circuit board with a solar cell mounted thereon is adhered directly onto a heat pipe that has its own heat dissipation function and extends in a longitudinal direction and the heat pipe is adhered directly onto portions of the lower plate, below which heat dissipation ribs are formed, and thus heat generated from the solar cell may be smoothly dissipated to a wide area by the heat pipe and then may be sequentially and effectively dissipated to the outside by the lower plate, thereby maximizing a heat dissipation effect.

A high concentration solar cell module according to the present invention may be configured in such a way that a thermally conductive pressing member sheet such as a low melting point solder containing tin (Sn), indium (In), silver (Ag), copper (Cu), and so on is interposed between a circuit board and a heat pipe so as to more smoothly dissipate heat that is generated from a solar cell and dissipated to the heat pipe.

A high concentration solar cell module according to the present invention may further include a fixing elastic member coupled to a pair of accommodation portion formation ribs formed on a lower plate and pressing a secondary lens, and thus the secondary lens may be easily fixed, the heat pipe may be stably fixed together with the secondary lens, and contact between a circuit board and the heat pipe and contact between the heat pipe and a lower plate may be further enhanced, thereby maximizing a heat dissipation effect.

It will be appreciated by persons skilled in the art that that the effects that could be achieved with the present invention are not limited to what has been particularly described hereinabove and other advantages of the present invention will be more clearly understood from the following detailed description taken in conjunction with the accompanying drawings.

### DESCRIPTION OF DRAWINGS

FIG. 1 is a perspective view of a high concentration solar cell module according to an exemplary embodiment of the present invention.

FIG. 2 is a partial exploded cross-sectional view taken along a line A-A of FIG. 1.

FIG. 3 is a partial exploded cross-sectional view taken along a line B-B of FIG. 1.

FIG. 4 is a perspective view illustrating a solar cell assembly according to an exemplary embodiment of the present invention.

FIG. 5 is a partial enlarged view of a region ‘C’ of FIG. 2.

FIG. 6 is a partial enlarged view of a region ‘D’ of FIG. 3.

FIG. 7 is a diagram illustrates a state in which a solar cell assembly is coupled to the lower plate.

FIG. 8 is an exploded perspective view of a solar cell assembly and a lower plate.

FIG. 9 is a schematic plan view of a circuit board.

### BEST MODE

Hereinafter, exemplary embodiments of the present invention will be described in detail with reference to the attached drawings.

This invention may, however, be embodied in many different forms, and should not be construed as limited to the embodiments set forth herein. Rather, all changes that fall within the bounds of the present invention, or the equivalence of the bounds, are therefore intended to be embraced by the present invention.

In the drawings, the size of each element, the thickness of lines illustrating the element, etc. may be exaggeratedly expressed in the drawings for clarity of illustration, but due to this, the protective scope of the present invention should not be interpreted narrowly.

In this specification, the relative terms ‘vertical direction’ and ‘horizontal direction’ are just relative terms for use in explaining the relationship between elements based on the orientation indicated in the drawings. The scope of the present invention is not restricted by these terms.

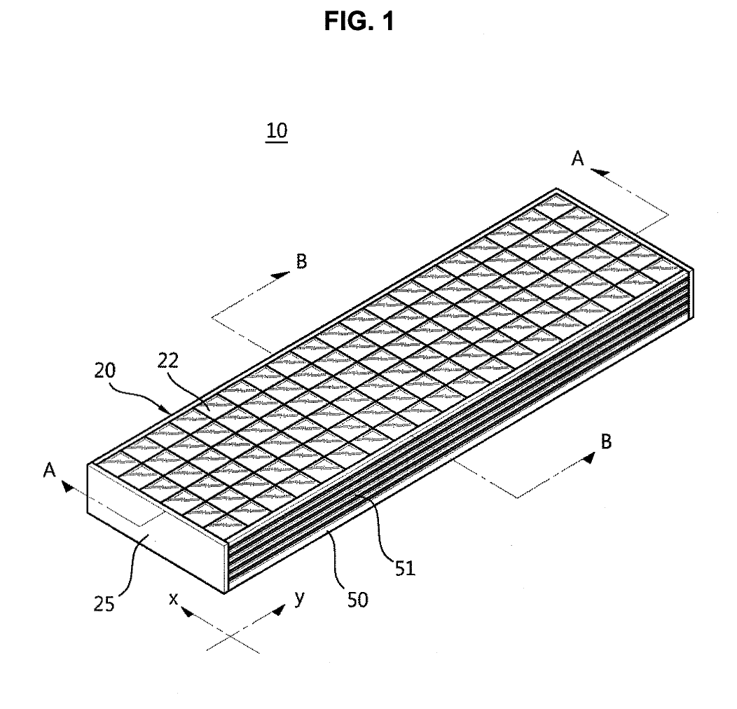

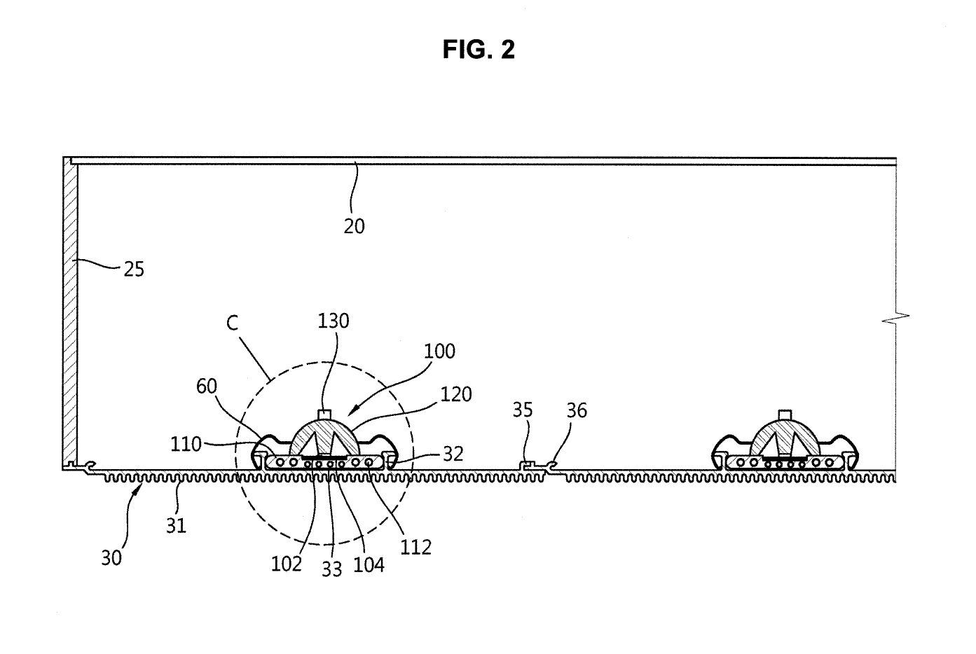

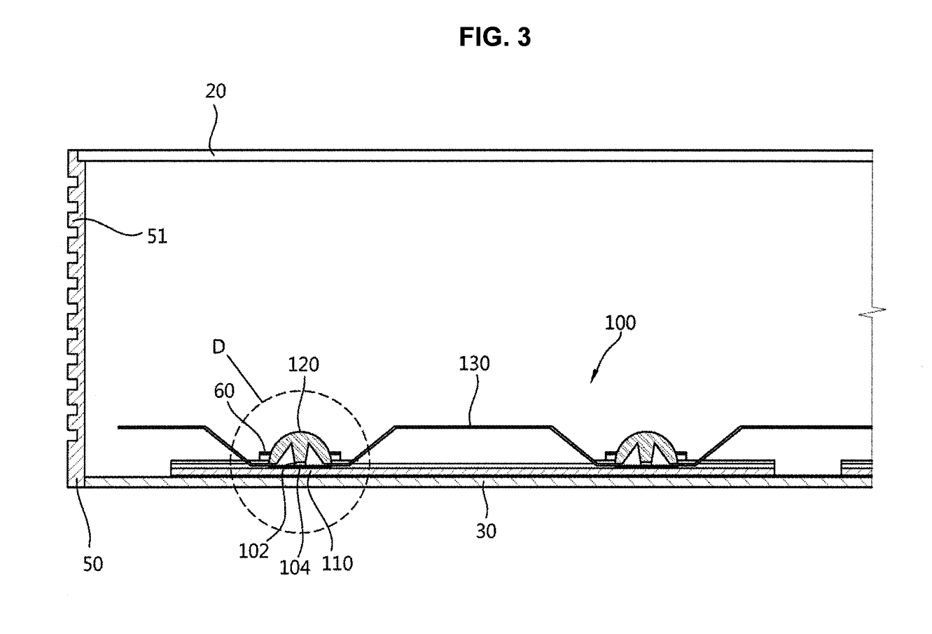

FIG. 1 is a perspective view of a high concentration solar cell module 10 according to an exemplary embodiment of the present invention. FIG. 2 is a partial exploded cross-sectional view taken along a line A-A of FIG. 1. FIG. 3 is a partial exploded cross-sectional view taken along a line B-B of FIG. 1.

Referring to FIGS. 1 to 3, the high concentration solar cell module 10 according to the exemplary embodiment of the present invention may include a frame including a side plate and a lower plate 30, a solar cell assembly 100 including a solar cell 102 and coupled to the lower plate 30, and a lens plate 20 disposed on the frame and for concentrating sunlight incident thereon on the solar cell 102.

The frame may extend a predetermined length in a longitudinal direction ‘y’ and has comparatively high stiffness. The frame includes the side plate and the lower plate 30 and is configured to be open on an upper side thereof.

The side plate includes a horizontal plate 25 that extends a comparatively small length in a horizontal direction ‘x’ and a vertical plate 50 that extends a greater length than the horizontal plate 25 in a vertical direction ‘y’.

The vertical plate 50 may include a plurality of ribs 51 for enhancement of stiffness. The heat dissipation ribs 51 may protrude from an external side surface of the vertical plate 50 to enhance the stiffness of the vertical plate 50 and to simultaneously increase a contact area with the outside, thereby smoothly and externally transmitting and dissipating heat transferred from a closed interior of the frame to the vertical plate 50.

Although not illustrated, a coupling rib for screw-coupling with the vertical plate 50 may protrude on an inner or outer surface of the horizontal plate 25. The coupling rib functions not only to enhance the stiffness of the horizontal plate 25 but also to facilitate the screw-coupling with the vertical plate 50.

The vertical plate 50, the horizontal plate 25, and the lower plate 30 that constitute a frame may be formed of aluminum that is light, has its own stiffness, and has high heat conductivity. In addition, the frame, that is, the vertical plate 50, the horizontal plate 25, and the lower plate 30 may be integrally manufactured by extrusion molding so as to be easily manufactured and assembled and to have a structure with its own stiffness.

The lens plate 20 may be provided on the frame and concentrate incident sunlight on the solar cell 102. The lens plate 20 may include a plurality of pattern portions 22 that concentrate incident sunlight on each of the solar cells 102. The pattern portion 22 may have the same structure as that of a Fresnel lens. That is, the lens plate 20 is configured in such a way that a plurality of Fresnel lens patterned parts is formed in a plate. In addition, the lens plate 20 may be configured with a single plate or a plurality of piece lens plates that are provided on the frame and coupled.

The solar cell assembly 100 may be configured to maximize a heat dissipation effect with a simple configuration and to simultaneously simplify assembly. Hereinafter, the configuration of the solar cell assembly 100 will be described in detail.

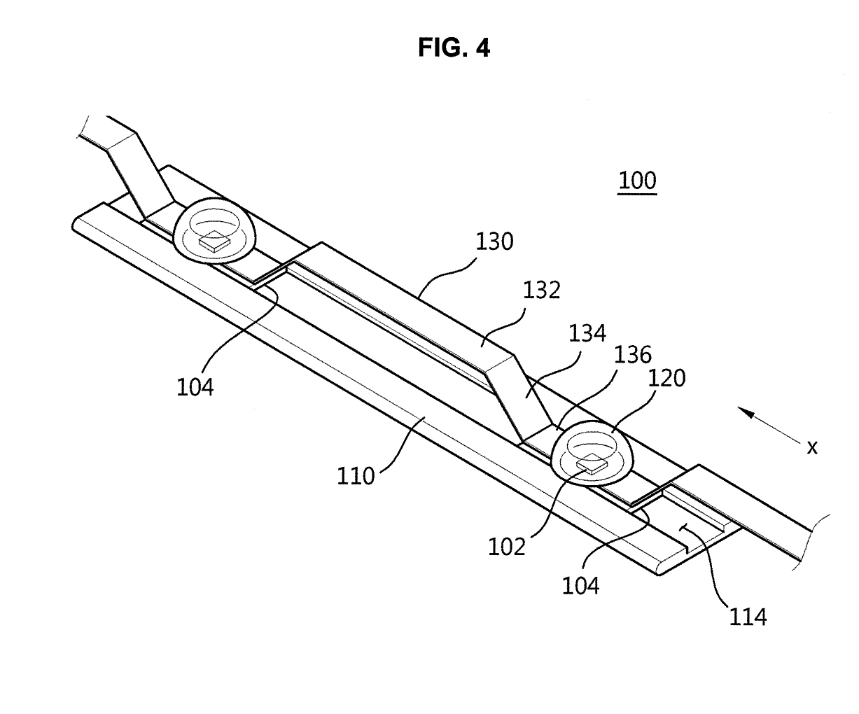

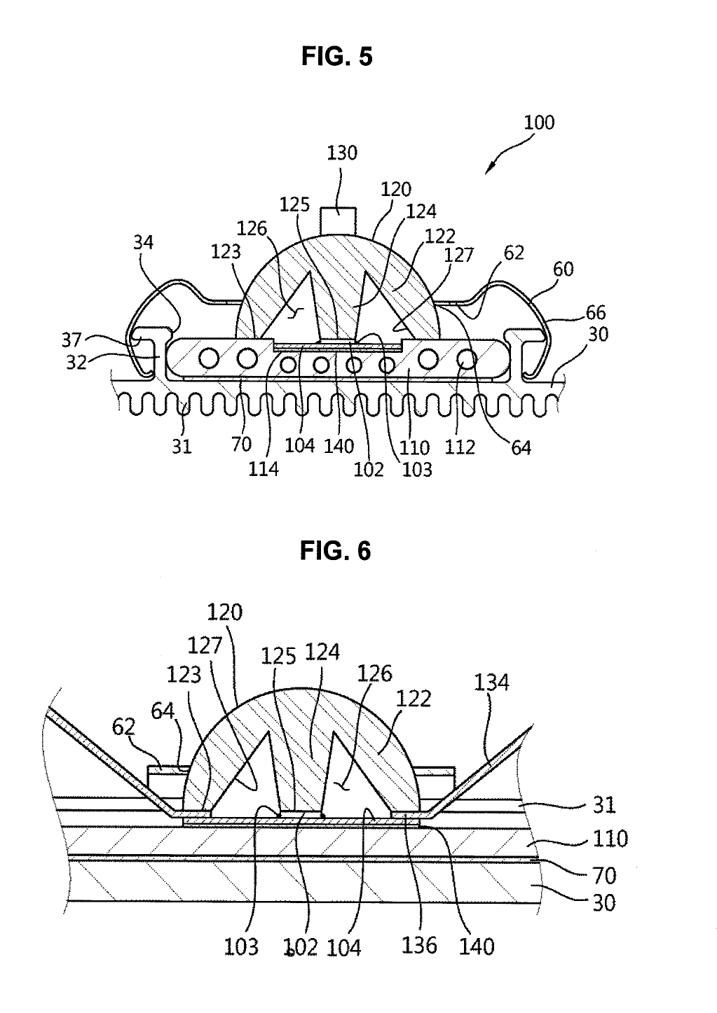

FIG. 4 is a perspective view illustrating a solar cell assembly 100 according to an exemplary embodiment of the present invention. FIG. 5 is a partial enlarged view of a region ‘C’ of FIG. 2. FIG. 6 is a partial enlarged view of a region ‘D’ of FIG. 3.

Referring to FIGS. 2 to 6, the solar cell assembly 100 according to the exemplary embodiment of the present invention may include a heat pipe 110 that extends in a longitudinal direction (a horizontal direction ‘x’), the circuit board 104 with the solar cell 102 mounted thereon, and a wire 130 for electric connection of the solar cell 102.

The solar cell 102 may convert solar energy into electric energy. A high efficiency III-V compound semiconductor multi-junction solar cell may be used as the solar cell 102. The circuit board 104 may be configured in such a way that the solar cell 102, along with other elements, is mounted to a circuit board. A receiver typically used in this art pertaining to the present invention may be used as the circuit board 104. That is, according to the present invention, the circuit board 104 formed in such a way that the solar cell 102 is provided on the circuit board may be configured in a variety of forms.

The circuit board 104 may be adhered onto the heat pipe 110 by soldering or the like. That is, the solar cell assembly 100 according to the exemplary embodiment of the present invention may be configured in such a way that the circuit board 104 with the solar cell 102 mounted thereon is adhered directly onto the heat pipe 110, which has a heat dissipation function and extends in a longitudinal direction, via soldering or the like so as to effectively dissipate heat generated from the solar cell 102, and thus heat generated from the solar cell 102 may be effectively transferred in a longitudinal direction of the heat pipe 110 so as to be dissipated to a wide area.

In detail, a refrigerant pipe 112 in which a refrigerant circulates may be formed in a longitudinal direction (or a horizontal direction ‘x’) in the heat pipe 110. In this regard, heat generated from the solar cell 102 amounted on the circuit board 104 may be transferred to a refrigerant pipe 112 positioned immediately below the solar cell 102, and a refrigerant present in a corresponding region of the refrigerant pipe 112 may evaporate by the transferred heat and may condense while flowing to an adjacent region and then may return to a position when the refrigerant initially evaporates. In this regard, according to this circulating process, heat generated from the solar cell 102 may be dissipated to a wider area if possible in a longitudinal direction of the heat pipe 110.

As illustrated in FIG. 4, the solar cell assembly 100 according to the present invention may be configured in such a way that a plurality of circuit boards 104 in which one solar cell 102 is installed in one heat pipe 110 are spaced apart from each other by a predetermined interval in a longitudinal direction of the heat pipe 110. Accordingly, heat generated from the plurality of solar cells 102 may be more effectively transferred in a longitudinal direction of the heat pipe 110 so as to be dissipated to a wider area if possible and to simultaneously simplify overall configuration and assembly.

However, FIG. 4 illustrates an exemplary embodiment of the solar cell assembly 100 according to the present invention, but the present invention is not limited thereto and one circuit board 104 may be adhered to one heat pipe 110. In addition, the circuit boards 104 are spaced apart from each other by a predetermined interval, and thus even if one circuit board 104 is adhered to one heat pipe 110, the heat pipe 110 may sufficiently extend in a longitudinal direction so as to achieve the aforementioned effect.

A thermally conductive pressing member sheet 140 formed of a thermal interface material (TIM) material may be interposed between the circuit board 104 and the heat pipe 110. Accordingly, heat generated from the solar cell 102 mounted on the circuit board 104 may be more smoothly transferred to the heat pipe 110 so as to maximize a heat dissipation effect. Here, a low melting point solder containing tin (Sn), indium (In), silver (Ag), copper (Cu), and so on may be used as the thermally conductive pressing member sheet 140. However, the present invention may not be limited thereto.

The wire 130 may be a component that connects in series or parallel the plurality of solar cells 102 spaced apart by a predetermined interval so as to electrically connect the solar cells 102 to each other and may include a ribbon wire 30 that is not peeled off. Accordingly, a separate wire cover configuration for protection of a conventional peeled-off wire from off-axis sunlight is not required so as to simply overall configuration and assembly.

The ribbon wire 30 may include a length portion 32, a pair of step difference portions 34 that extend downward from opposite sides of the length portion 32, and a pair of flange portions 36 that extend from the step difference portions 34.

The pair of flange portions 36 may be a component for connection with the circuit board 104, may be adhered to the circuit board 104 via soldering, and may support the ribbon wire 30 after the adherence. That is, the ribbon wire 30 may be adhered to the circuit boards 104 that are spaced apart from each other by positioning the pair of flange portions 36 to be adjacent to each other by soldering, welding, and so on so as to have its own fixed structure. The ribbon wire 30 may be fixed in a more stable state and may be formed in a plate form with a predetermined width so as to have sufficient conductive capability.

In addition, the ribbon wire 30 may be configured in such a way that the length portion 32 is maintained to be spaced apart upward from the ground by a predetermined interval by the pair of flange portions 36 and the pair of step difference portions 34, and thus a separate configuration for insulation of the length portion 32 is not required, thereby simplifying overall configuration and assembly.

The solar cell assembly 100 may further include a secondary lens 120 that is disposed on the heat pipe 110 so as to cover the circuit board 104 and concentrates sunlight concentrated by a lens plate 20 on the solar cell 102.

The secondary lens 120 may include a cover portion 122 that covers the circuit board 104 and a lens portion 124 that extends downward from a central portion of the cover portion 122 and concentrates light incident on the central portion of the cover portion 122 to the solar cell 102 according to total internal reflection, and a predetermined space 126 may be formed in the secondary lens 120.

Accordingly, the solar cell assembly 100 according to the present invention may be configured in such a way that the solar cell 102 and the circuit board 104 are protected from the outside by the cover portion 122 of the secondary lens 120, and thus a separate structure for protection of the solar cell 102 and the circuit board 104, thereby simplifying overall configuration and assembly.

The secondary lens 120 may be formed of a transparent material via one body molding. Examples of the transparent material glass, methylmethacrylate, polymethylmethacrylate (PMMA), polycarbonate (PC), and poly ethylen terephthalate (PET), which are each a transparent material with excellent light transmittance.

A groove 114 that extends in a longitudinal direction may be formed in an upper portion of the heat pipe 110, and the circuit board 104 may be disposed in the groove 114. Accordingly, the secondary lens 120 may be easily disposed on the circuit board 104.

In detail, since the cover portion 122 is formed with a size so as to completely cover the solar cell 102 and the circuit board 104, a lower surface 123 of the cover portion 122 may substantially contact with an upper surface of the heat pipe 110, and although a lower surface 125 of the lens portion 124, as an emitting surface from which sunlight incident on the lens portion 124 is emitted, needs to contact the solar cell 102 with a minimum interval, if the heat pipe 110 is flat without the groove 114, the lower surface 123 of the cover portion 122 and the lower surface 125 of the lens portion 124 are different by as much as the sum of the thickness of the circuit board 104 and the thickness of the solar cell 102, and thus it is difficult to dispose the secondary lens 120 on the heat pipe 110 and also difficult to manufacture the secondary lens 120. For example, it may be inconvenient to manufacture the secondary lens 120 with a transparent material through integration molding and then to process the lower surface 125 of the lens portion 124 through a separate process such that the lower surface 125 of the lens portion 124 is smaller than the lower surface 123 of the cover portion 122 by as much as the sum of the thickness of the circuit board 104 and the sum of the solar cell 102. However, as described above, when the groove 114 that extends in a longitudinal direction is formed in the upper portion of the heat pipe 110 and the circuit board 104 is adhered onto a lower surface of the groove 114, the secondary lens 120 may be easily manufactured and the secondary lens 120 may be easily disposed on the circuit board 104.

The depth of the groove 114 may be greater than the sum of the thickness of the circuit board 104 and the thickness of the solar cell 102. Accordingly, when the secondary lens 120 configured in such a way that the lower surface 123 of the cover portion 122 is disposed in substantially parallel to the lower surface 125 of the lens portion 124 is disposed on the circuit board 104, the lower surface 123 of the cover portion 122 may substantially contact the heat pipe 110 and simultaneously the lower surface 125 of the lens portion 124 may contact the solar cell 102 with a minimum interval. In addition, as such, when the secondary lens 120 is disposed on the circuit board 104, if the lower surface 123 of the lens portion 124 substantially contacts the solar cell 102, the solar cell 102 and the lower surface 125 of the lens portion 124 may be adhered using a transparent sealing member 103 such as silicon so as to couple the secondary lens 120 onto the solar cell 102 without a separate configuration and to easily seal the solar cell 102.

The secondary lens 120 may further include an internal side surface 127 that prevents a light beam that is not incident on the lens portion 124 among light beams that are concentrated by the lens plate 20 and incident on the cover portion 122 from being incident on the circuit board 104. The internal side surface 127 may be formed via coating so as to reflect light that is not incident on the lens portion 124 or may be optically designed so as to totally reflect the light. The internal side surface 127 may prevent a plurality of components installed in the circuit board 104 from being damaged from off-axis light that is not incident on the lens portion 124 due to failure of a sunlight tracking apparatus for maintaining the high concentration solar cell module 10 and sunlight to be perpendicular to each other.

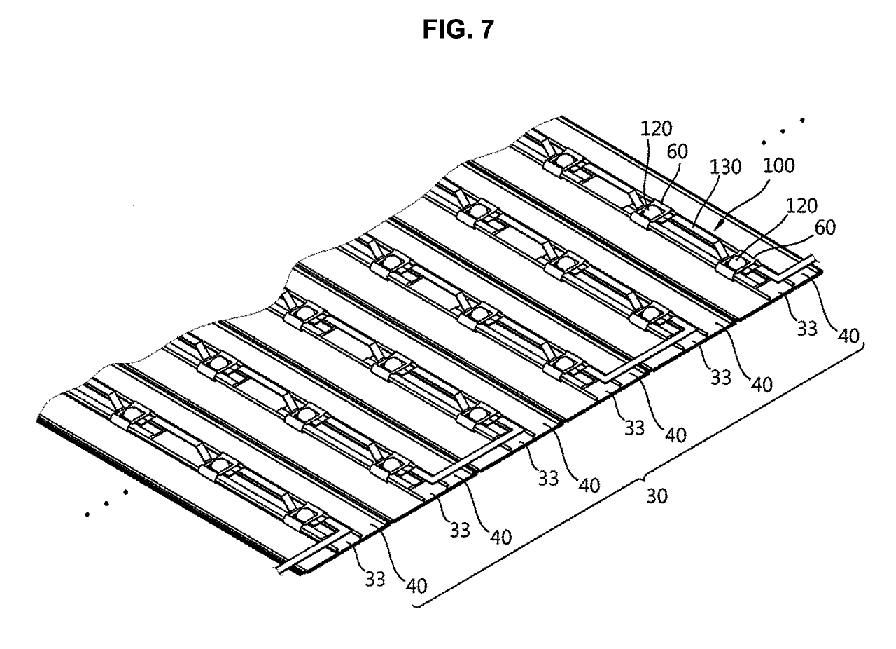

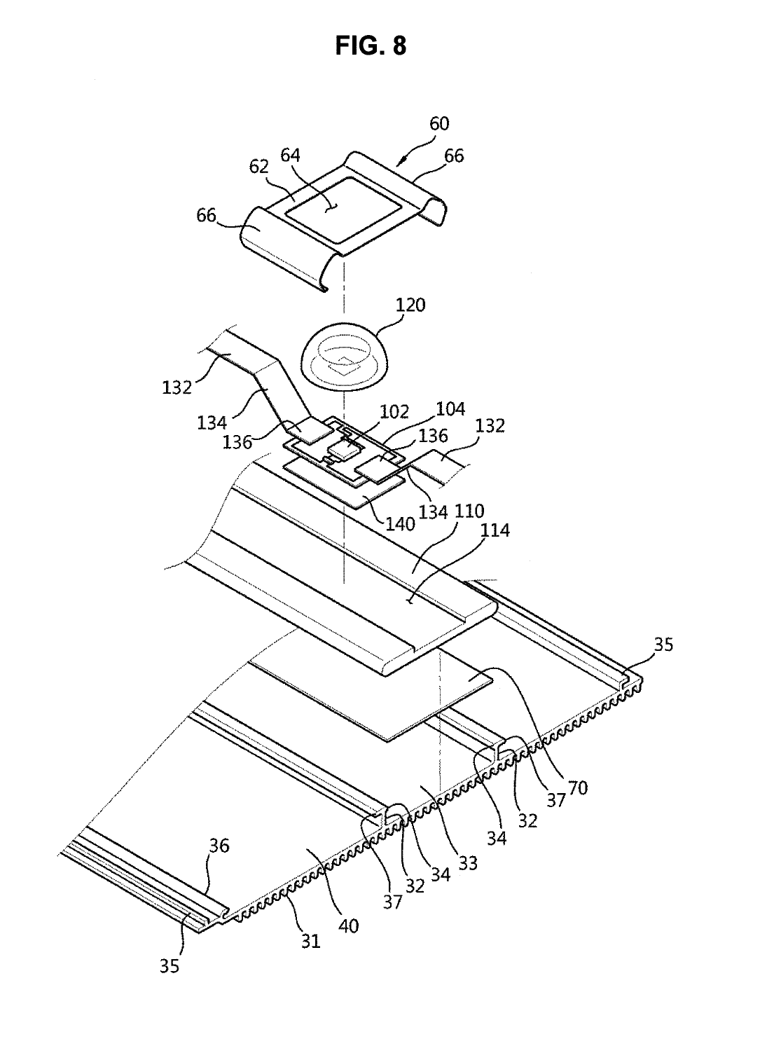

FIG. 7 is a diagram illustrates a state in which the solar cell assembly 100 is coupled to the lower plate 30 and FIG. 8 is an exploded perspective view of the solar cell assembly 100 and the lower plate 30.

Referring to FIGS. 2, 7, and 8, the lower plate 30 may include an accommodation portion 33 that accommodates the heat pipe 110 that extends in a longitudinal direction and extends in a horizontal direction ‘x’, and the accommodation portion 33 may be configured by forming a pair of accommodation portion formation ribs 32 protruding on the lower plate 30 to extend in the longitudinal direction ‘x’.

In addition, heat dissipation ribs 31 may protrude below the lower plate 30.

Accordingly, the high concentration solar cell module 10 according to the present invention may be configured in such a way that the circuit board 104 with the solar cell 102 mounted thereon is adhered directly onto the heat pipe 110 that has its own heat dissipation function and extends in a longitudinal direction and the heat pipe 110 is adhered directly onto portions of the lower plate 30, below which the heat dissipation ribs 31 are formed, and thus heat generated from the solar cell 102 may be effectively dissipated to a wide area by the heat pipe 110 and then may be sequentially and effectively dissipated to the outside by the lower plate 30, thereby maximizing a heat dissipation effect.

In detail, heat generated from a plurality of solar cells 102 arranged in a longitudinal direction of the heat pipe 110 may be rapidly transferred in a longitudinal direction of the heat pipe 110 through the heat pipe 110 before being transferred into the high concentration solar cell module 10, and the heat that is rapidly transferred in the longitudinal direction may be externally dissipated through the lower plate 30. In this case, the heat transferred to the lower plate 30 may be more effectively dissipated to the outside by the heat dissipation ribs 31 formed below the lower plate 30.

An internal flange 34 for fixing the heat pipe 110 accommodated on the accommodation portion 33 may be formed on an internal surface of the accommodation portion formation rib 32. Accordingly, when the heat pipe 110 is coupled to the accommodation portion 33 while the heat pipe 110 is press-fit with the accommodation portion 33 or the lower plate 30 is slightly bent, the heat pipe 110 may be fixed with its opposite sides stumbled by the internal flange 34. Accordingly, the high concentration solar cell module 10 according to the present invention may be configured in such a way that the solar cell assembly 100 is easily coupled and fixed to the lower plate 30 without separate screw coupling, thereby simplifying overall configuration and assembly.

A thermally conductive pressing member sheet 70 formed of a thermal interface material (TIM) material may be interposed between the accommodation portion 33 and the heat pipe 110. Accordingly, heat transferred to the heat pipe 110 may be more smoothly transferred to the lower plate 30 so as to maximize a heat dissipation effect. Here, a low melting point solder containing tin (Sn), indium (In), silver (Ag), copper (Cu), and so on may be used as the thermally conductive pressing member sheet 70. However, the present invention may not be limited thereto.

As illustrated in FIG. 7, a plurality of solar cell assemblies 100 may be arrayed on the accommodation portion 33 of the lower plate 30 in a longitudinal direction ‘x’, the plurality of solar cell assemblies 100 that are arrayed in the longitudinal direction ‘x’ may be coupled on the lower plate 30 so as to be arrayed in a vertical direction ‘y’ by a predetermined interval, and a plurality of solar cells 102 included in the solar cell assemblies 100 arranged likewise may be electrically connected to each other by the ribbon wire 130.

The lower plate 30 includes a plurality of lower plate pieces 40 each of which has a predetermined width with respect to the vertical direction ‘y’ and that are arranged in the vertical direction ‘y’ to be coupled to each other and are screw-coupled to the vertical plate 50. In addition, the heat dissipation ribs 31 may be formed below each lower plate piece 40, coupling ribs 35 coupled to an adjacent lower plate piece 40 may be formed at opposite end portions of each lower plate piece 40, and at least one of a screw-coupling rib 36 for screw-coupling with the vertical plate 50 and the pair of accommodation portion formation ribs 32 may be formed on each lower plate piece 40. Although the drawing illustrates an embodiment in which one pair of accommodation portion formation ribs 32 is formed on one lower plate piece 40, the present invention is not limited thereto. Two or more pairs of accommodation portion formation ribs 32 may be formed, and thus the solar cell assemblies 100 arranged in the horizontal direction ‘x’ may be arranged on one lower plate piece 40 in the vertical direction ‘y’.

The stiffness of the lower plate piece 40 may be enhanced by the heat dissipation ribs 31, the pair of accommodation portion formation ribs 32, the coupling rib 35, the screw-coupling rib 36, and so on. The heat dissipation ribs 31 may increase the contact area with the outside such that heat transferred from the closed interior of the frame to the lower plate piece 40 may be smoothly transferred and dissipated to the outside. Furthermore, the lower plate pieces 31 formed of a thin board may be easily coupled and assembled by the coupling rib 35 and the screw-coupling rib 36.

The high concentration solar cell module 10 according to the present invention may further include a fixing elastic member 60 coupled to the pair of accommodation portion formation ribs 32 while pressing the secondary lens 120.

The fixing elastic member 60 may include a body portion 62, a pair of leg portions 66 that extend downward from opposite sides of the body portion 62 and press-fit with an external protrusion 37 protruding on an external surface of the pair of accommodation portion formation ribs 32, and an insertion fixing hole 64 into which an upper portion of the secondary lens 120 is inserted when the pair of leg portions 66 is press-fit with the external protrusion 37. Accordingly, the fixing elastic member 60 may press the secondary lens 120 with the body portion 62 inserted into the insertion fixing hole 64 when the pair of leg portions 66 are press-fit with the external protrusion 37. Here, the insertion fixing hole 64 may allow sunlight concentrated by the lens plate 20 to be incident on the lens portion 124, and the upper portion of the secondary lens 120, which is inserted into the insertion fixing hole 64, may approximately correspond to a central portion of the cover portion 122.

In addition, when the fixing elastic member 60 presses the secondary lens 120, the fixing elastic member 60 simultaneously presses the heat pipe 110, and thus the secondary lens 120 may be easily fixed to the lower plate 30 and the heat pipe 110 may also be stably fixed together with the secondary lens 120. In addition, according to the pressing of the fixing elastic member 60, contact between the circuit board 104 and the heat pipe 110 and contact between the heat pipe 110 and the lower plate 30 may be further enhanced, thereby maximizing a heat dissipation effect. In addition, most sunlight beams incident on an upper portion of the secondary lens 120 protruding toward the insertion fixing hole 64 of the fixing elastic member 60 may be incident on the lens portion 124 and may be concentrated on the solar cell 102, but most off-axis light beams that are not incident on the lens portion 124 may be blocked or reflected by the body portion 62 of the fixing elastic member 60, thereby preventing the circuit board 104 from being damaged due to automatically off-axis light beams.

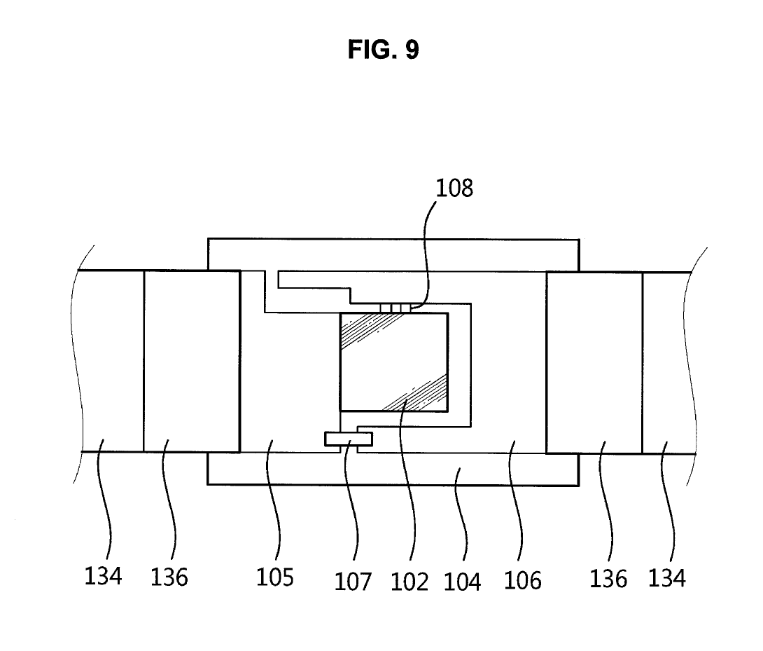

FIG. 9 is a schematic plan view of the circuit board 104.

Referring to FIG. 9, the solar cell 102 may be installed in an approximate central portion of the circuit board 104, and two electrical conductive connection portions 105 and 106 that are not electrically connected may be formed at opposite sides based on the solar cell 102 on a surface of the circuit board 104. Any one 105 of the two electrical conductive connection portions 105 and 106 may be connected directly to the solar cell 102, the other one 106 may be connected to the solar cell 102 by a lead wire 108, a by-pass diode 107 may be disposed between the two electrical conductive connection portions 105 and 106, and a flange portion 136 of the ribbon wire 130 may be adhered to the two electrical conductive connection portions 105 and 106 via methods such as soldering, welding, etc. Accordingly, the plurality of solar cells 102 spaced apart by a predetermined interval may be electrically connected by the ribbon wire 130.

As described above, the present invention relates to a high concentration solar cell module for enhancing a heat dissipation function and assembly with a simple configuration. The present invention may be embodied in a variety of forms. Therefore, the present invention is not limited to the embodiments disclosed in this specification. All changes that fall within the bounds of the present invention, or the equivalence of the bounds, should be understood to be embraced by the present invention.

1-16. (canceled)

17. A high concentration solar cell module comprising:
a frame comprising side plates and a lower plate;
a solar cell assembly comprising a solar cell and coupled to the lower plate; and
a lens plate disposed on the side plates and concentrating incident light to the solar cell,
wherein:
a pair of accommodation portion formation ribs extends and protrudes in a horizontal direction so as to dispose an accommodation portion for accommodating the solar cell assembly on the lower plate, and the solar cell assembly is press-fit with the accommodation portion.

18. The high concentration solar cell module according to claim 17, wherein the solar cell assembly comprises:
a heat pipe extending in a longitudinal direction and press-fit with the accommodation portion;
a circuit board comprising a solar cell mounted thereon and adhered to the heat pipe; and
a wire for electrically connecting the plurality of solar cells to each other.

19. The high concentration solar cell module according to claim 18, further comprising an internal flange formed on an internal surface of the accommodation portion formation rib and for fixing the heat pipe press-fit with the accommodation portion.

20. The high concentration solar cell module according to claim 18, wherein the heat pipe comprises a groove formed in the longitudinal direction and the plurality of circuit boards are spaced apart from each other in the groove of the heat pipe by a predetermined interval.

21. The high concentration solar cell module according to claim 18, further comprising a thermally conductive pressing member sheet interposed in at least one of between the circuit board and the heat pipe and between the accommodation portion and the heat pipe.

22. The high concentration solar cell module according to claim 18, wherein:
the solar cell assembly further comprises a secondary lens disposed on the heat pipe so as to cover the circuit board and concentrating light concentrated by the lens plate to the solar cell; and
the high concentration solar cell module further comprises a fixing elastic member coupled to the pair of accommodation portion formation ribs while pressing the secondary lens.

23. The high concentration solar cell module according to claim 22, wherein:
the fixing elastic member comprises a body portion, a pair of leg portions that extend downward from opposite sides of the body portion and press-fit with an external protrusion protruding on an external surface of the pair of accommodation portion formation ribs, and an insertion fixing hole into which an upper portion of the secondary lens is inserted when the pair of leg portions is press-fit with the external protrusion; and
the fixing elastic member presses the secondary lens with the body portion inserted into the insertion fixing hole when the pair of leg portions are press-fit with the external protrusion.

24. The high concentration solar cell module according to claim 22, wherein:
the heat pipe comprises a groove formed in the longitudinal direction and the circuit board is disposed in the groove;
the secondary lens comprises a cover portion for covering the circuit board and a lens portion that extends downward from a central portion of the cover portion and concentrates light incident on the central portion of the cover portion to the solar cell according to total internal reflection;
a depth of the groove is greater than the sum of a thickness of the circuit board and a thickness of the solar cell; and
a lower surface of the lens portion and an upper surface of the solar cell are adhered to each other with a predetermined interval by a transparent sealing member.

25. The high concentration solar cell module according to claim 18, wherein:
the wire comprises a ribbon wire that is not peeled off; and
the ribbon wire comprises a length portion with a predetermined width and a predetermined length, a pair of step difference portions extending downward from opposite sides of the length portion, and a pair of flange portions connected to the circuit board and extending from the step difference portions so as to support the ribbon wire.

26. The high concentration solar cell module according to claim 17, wherein:
the side plate comprises a horizontal plate and a vertical plate extending a greater length than the horizontal plate;
the lower plate comprises a plurality of piece lower plates that are coupled in a vertical direction and screw-coupled to the vertical plate; and
each of the plurality of piece lower plates comprises the pair of accommodation portion formation ribs, the heat dissipation rib protruding below each of the plurality of piece lower plates, a coupling rib coupled to an adjacent piece lower plate, and a screw-coupling rib for screw-coupling with the vertical plate.
